(19) United States
(12) Patent Application Publication
(10) Pub. No.: US 2024/0112010 A1
(43) Pub. Date: Apr. 4, 2024

(54) IDENTIFYING PERFORMANCE DEGRADATION IN MACHINE LEARNING MODELS BASED ON COMPARISON OF ACTUAL AND PREDICTED RESULTS

(71) Applicant: Capital One Services, LLC, McLean, VA (US)

(72) Inventors: Gaurav JAIN, Plano, TX (US); Phanindra RAO, Celina, TX (US); Chun-Hsiung LU, McLean, VA (US)

(73) Assignee: Capital One Services, LLC, McLean, VA (US)

(21) Appl. No.: 17/936,522

(22) Filed: Sep. 29, 2022

(51) Int. Cl. G06N 3/08

(52) U.S. Cl. CPC G06N 3/08

(57) ABSTRACT

Methods and systems are described herein for identifying performance degradation in machine learning models based on comparisons of actual and predicted results. The system may receive predicted and actual results datasets for features within a system with the predicted results being generated by a machine learning model corresponding to the feature. The system may access a hierarchy associated with the features and select a level of the hierarchy having a subset of features. The subset of features may be associated with a target feature. Impact values may then be generated for the subset, where the impact values indicate contributions of the corresponding features to a difference, in the target feature, between predicted and actual results. The system may select a new target feature, from the subset, associated with a highest impact value and may retrain a machine learning model associated with the new target feature.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. Results based on artificial intelligence are notoriously difficult to review as the process by which the results are made may be unknown or obscured. This obscurity creates hurdles for identifying errors in the results and for improving the models providing those results. For example, performance of machine learning models may degrade over time. Generally, a user is able to determine that a machine learning model has degraded based on comparing actual results to predicted results. However, some datasets include values predicted based on data from multiple machine learning models. For example, a particular value may be calculated from a combination of values that are derived from different machine learning models. Thus, it is difficult to determine which machine learning model's performance has degraded.

### SUMMARY

Methods and systems are described herein for identifying performance degradation in machine learning models, in particular situations such as when dataset values are derived from a combination of outputs from different machine learning models. For example, computing systems may use multiple machine learning models to make predictions for various metrics. However, one or more of these machine learning models may experience performance degradation over time. Discovering which machine learning model has the greatest performance degradation in such systems is essential to improving accuracy, yet this is difficult to ascertain due to the obscurity of such systems.

To overcome this technical deficiency, methods and systems disclosed herein identify performance degradation in one or more machine learning models based on a comparison of actual and predicted results of a number of features. For example, a system may receive both a predicted dataset and an actual dataset. The predicted dataset may include values predicted by multiple machine learning models. The actual results may include observation data. Although, a user or a system may determine a difference between the actual and predicted results, indicating a performance degradation, it is difficult to pinpoint which machine learning model is experiencing performance degradation. To solve this problem, the system may process a hierarchy of features to arrive at a target feature of interest (e.g., a feature generated by a particular machine learning model that shows a difference between actual and predicted results) thereby determining a machine learning model that has degraded. In particular, the system may calculate contributions of the features at the top level of the hierarchy to a difference, in the target feature, between the actual and predicted results. The system may then select a new target feature having the highest contribution (of the features at the top level) and may repeat this process until the bottom level of the hierarchy is reached. Accordingly, this mechanism enables tracing features contributing to performance degradation in machine learning models and retraining those machine learning models to improve the accuracy of the system.

In some embodiments, the system may receive a predicted results dataset and an actual results dataset. The predicted results dataset may include a first plurality of entries for a plurality of features. For example, the first plurality of entries may include predicted data for each feature of the plurality of features. The predicted data may be generated by a corresponding machine learning model associated with each feature. The actual results dataset may include a second plurality of entries for the plurality of features, where the second plurality of entries includes observed data for each feature of the plurality of features. In one example, the disclosed mechanism may enable a user to identify performance degradation in machine learning models used for server load optimization. Thus, a user may determine driving features of a difference in predicted usage of servers versus actual usage of the servers. In particular, the system may receive a predicted results dataset including predicted usage (e.g., power, network, processor, memory, etc.) for a plurality of servers within a datacenter, where each entry is predicted by a corresponding machine learning model. The system may additionally receive an actual results dataset including actual usage for those servers.

The system may access a hierarchy associated with the plurality of features (e.g., power, network, processor, memory, etc.). In some embodiments, the hierarchy may include an initial target feature and a plurality of levels, each level indicating a subset of features of the plurality of features. The system may select a first level of the hierarchy, where the first level of the hierarchy indicates a first subset of the plurality of features. For example, the system may access a hierarchy that includes features indicating various loads on the plurality of servers (e.g., power, network, processor, memory, etc.). Values within some of the features may be affected by values within other features. For example, power consumption may be affected by processor usage and/or memory usage. The hierarchy may include an initial target feature (e.g., power consumption) as well as levels of features within the same system. The system may then select a first level of the hierarchy indicating a first subset of features. For example, the first subset of the features may feed into the initial target feature.

The system may generate a first set of impact values for the first subset of the plurality of features. In some embodiments, each impact value may indicate a contribution of a corresponding feature to a difference, in the initial target feature, between predicted values of the predicted results dataset and actual values of the actual results dataset. For example, the system may generate impact values for the first subset of server load features (e.g., processor usage, memory usage, storage usage). Each impact value may indicate a contribution of the respective load feature to a difference, in the initial target feature (e.g., power usage), between predicted and actual power usage. The system may determine a new target feature (e.g., processor usage) for the first level of the hierarchy based on the new target feature having the highest impact value of the first subset of features.

The system may determine, for each subsequent level of the hierarchy based on the first set of impact values and subsequent sets of impact values, a feature at each subsequent level of the hierarchy having a highest impact value. In other words, the system may trace the features having the highest impact values down the levels of the hierarchy. For example, the system may determine impact values for each feature of the second features. The second subset of features may include features associated with processor usage such as arithmetic logic unit load, graphic processor usage, and/or coprocessor usage. The system may determine a new target feature from among the second subset of features based on the new target feature having the highest impact value of the second subset of features. The system may repeat this process until reaching the bottom of the hierarchy.

The system may select a final target feature at a final level of the hierarchy, where the final target feature is associated with a final highest impact value corresponding to the final level of the hierarchy. The system may then retrain a machine learning model used to generate final predicted values for the final target feature using a new training dataset. For example, the system may select a final target load feature (e.g., arithmetic logic unit load for a processor) at the final level of the hierarchy based on the final target feature having the highest impact value of a final subset of features. The system may retrain a machine learning model used to predict usage for the arithmetic logic unit, thereby identifying performance degradation of a particular machine learning model and addressing the issue.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part, or the entirety (i.e., the entire portion), of a given item (e.g., data) unless the context clearly dictates otherwise.

### BRIEF DESCRIPTION OF THE DRAWINGS

FIG. 1 shows an illustrative system for identifying performance degradation in machine learning models, in accordance with one or more embodiments.

FIG. 2 illustrates an excerpt of a data structure for actual and predicted datasets, in accordance with one or more embodiments.

FIG. 3 illustrates an exemplary machine learning model, in accordance with one or more embodiments.

FIG. 4 illustrates a hierarchy of features relating to a target feature, in accordance with one or more embodiments.

FIG. 5 illustrates a data structure representing impact values, in accordance with one or more embodiments.

FIG. 6 illustrates a computing device, in accordance with one or more embodiments.

FIG. 7 shows a flowchart of the process for identifying performance degradation in machine learning models, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art, that the embodiments of the invention may be practiced without these specific details or with an equivalent arrangement. In other cases, well-known structures and devices are shown in block diagram form in order to avoid unnecessarily obscuring the embodiments of the invention.

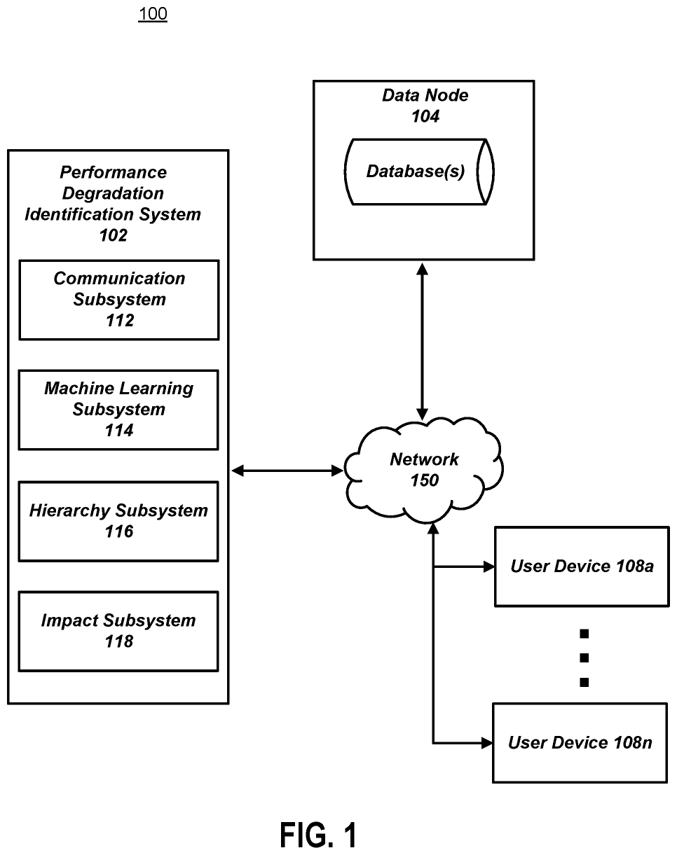

FIG. 1 shows an illustrative system 100 for identifying performance degradation in machine learning models, in accordance with one or more embodiments. System 100 includes performance degradation identification system 102, data node 104, and user devices 108a-108n. In some embodiments, only one user device may be used while in other embodiments multiple user devices may be used. In some embodiments, user devices 108a-108n may be a computing device that may receive and send data via network 150. User devices 108a-108n may be end-user computing devices (e.g., desktop computers, laptops, electronic tablets, smart phones, and/or other computing devices used by end users). User devices 108a-108n may output (e.g., via a graphical user interface) alerts, recommendations, or other data received from, for example, communication sub system 112.

Performance degradation identification system 102 may execute instructions for identifying performance degradation in machine learning models and retraining those machine learning models accordingly. Performance degradation identification system 102 may include software, hardware, or a combination of the two. For example, performance degradation identification system 102 may be hosted on a physical server or a virtual server that is running on a physical computer system. In some embodiments, performance degradation identification system 102 may be configured on a user device (e.g., a laptop computer, a smart phone, a desktop computer, an electronic tablet, or another suitable user device). In some embodiments, performance degradation identification system 102 may identify performance degradation in load optimization systems. For example, performance degradation identification system 102 may be used to determine driving factors in differences between predicted usage (e.g., as projected by machine learning models) and actual usage of servers within a network. In some embodiments, performance degradation identification system 102 may be used to identify performance degradation in other machine learning model systems.

Data node 104 may store various data, including one or more machine learning models (e.g., user machine learning models), training data, communications, and/or other suitable data. In some embodiments, data node 104 may also be used to train machine learning models. Data node 104 may include software, hardware, or a combination of the two. For example, data node 104 may be a physical server, or a virtual server that is running on a physical computer system. In some embodiments, performance degradation identification system 102 and data node 104 may reside on the same hardware and/or the same virtual server/computing device. Network 150 may be a local area network, a wide area network (e.g., the Internet), or a combination of the two.

In some embodiments, performance degradation identification system 102 may receive one or more datasets. For example, performance degradation identification system 102 may receive the datasets via communication subsystem 112. In some embodiments, performance degradation identification system 102 may select subsets of the received datasets for processing by the system. The datasets may include results for a plurality of features. In some embodiments, features may be interrelated elements of a network. For example, performance degradation identification system 102 may be used to identify performance degradation in machine learning models used for server load optimization. Server load optimization may include methods of improving data processing efficiency and application configuration to improve overall server performance within, for example a cloud-based system. In some embodiments, features may be independent variables relating to one or more dependent variables. For example, features may include independent variables (e.g., number of users, number of applications, network resources such as power, memory, and processors, or other variables) affecting a particular independent variable (e.g., server usage). In some examples, features may include other independent variables (e.g., revenue, expected loss, costs, and other independent variables) affecting a dependent variable (e.g., return on equity). In some embodiments, features may represent other elements of a system.

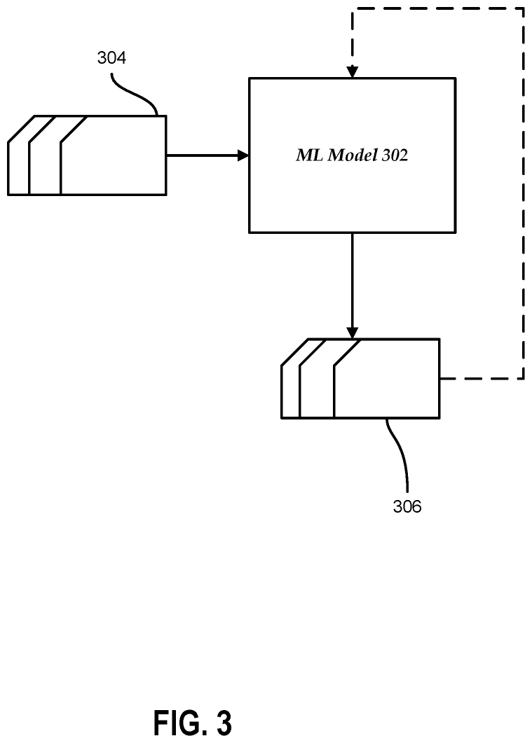

The datasets may include predicted or projected results datasets. The predicted results datasets may include entries of predicted values for the features. The predicted values may be generated by one or more machine learning models (e.g., as described in greater detail with relation to FIG. 3). In some embodiments, each feature may correspond to a machine learning model, such that predicted values for each feature are generated by the corresponding machine learning model. In some embodiments, performance degradation identification system 102 may generate the predicted results dataset. For example, performance degradation identification system 102 may receive predicted data for each feature from a corresponding machine learning model associated with the feature. Performance degradation identification system 102 may then generate the predicted values dataset by creating entries including the predicted data for each feature. In some embodiments, performance degradation identification system 102 may generate the predicted results dataset using other methods.

In some embodiments, the datasets may additionally include an actual or observed results dataset. For example, the actual results dataset may include entries of actual values for the features. The actual values may be observed and input into the system or received in some other way. In some embodiments, each feature may be associated with at least one value from each dataset (e.g., at least one predicted value and at least one actual value). In some embodiments, performance degradation identification system 102 may generate the actual results dataset. For example, performance degradation identification system 102 may receive observed data for each feature. Performance degradation identification system 102 may then generate the actual values dataset by creating entries including the observed data for each feature. In some embodiments, performance degradation identification system 102 may generate the actual results dataset using other methods.

Performance degradation identification system 102 may be used to determine features (e.g., server load features) driving a difference in predicted usage of a particular versus actual usage of the particular server. Thus, the predicted results dataset may include predicted usage values, each generated by a machine learning model for a server within the network. The predicted usage values may be predicted based on historical data, number of users, network resources, applications, predicted events, or other data. The actual results dataset may include observed usage values for each server within the network.

In some embodiments, the received datasets may include other data. For example, data structure 200 may include past results data and present results data. Datasets may include past results data and predicted results data. Datasets may include present results data and predicted results data. In some embodiments, datasets may include multiple past results datasets (e.g., August 2020 data versus August 2021 data) or multiple predicted results datasets (e.g., June 2050 data versus June 2055 data). In some embodiments, datasets may include other data. Systems and methods described herein may identify discrepancies between the aforementioned datasets or other datasets.

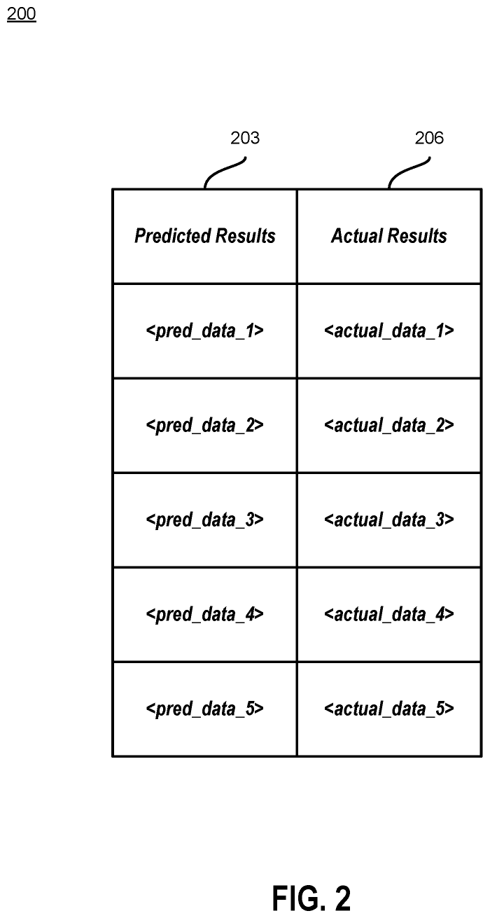

FIG. 2 illustrates a data structure 200 for actual and predicted datasets, in accordance with one or more embodiments. Data structure 200 may include predicted results 203 and actual results 206. As discussed above, predicted results 203 may be generated by machine learning models while actual results 206 represent observed data. In some embodiments, each entry in data structure 200 may correspond to a feature of a network. For example, first entries (e.g., <proj_data_1> and <actual_data_1>) may correspond to a first feature, second entries (e.g., <proj_data_2> and <actual_data_2>) may correspond to a second feature, and so on. In some embodiments, multiple entries may correspond to a single feature. In some examples, data structure 200 may be associated with a network of cloud-based servers. Each entry within data structure 200 may correspond to a feature (e.g., power usage, network usage, processor usage, memory usage, etc.) within the network such that data structure 200 includes at least one predicted results value and at least one actual results value for each server.

Performance degradation identification system 102 may receive the predicted results dataset via machine learning subsystem 114. Machine learning subsystem 114 may include multiple machine learning models. For example, machine learning subsystem 114 may include at least one machine learning model for each feature within the system.

FIG. 3 illustrates an exemplary machine learning model 302, in accordance with one or more embodiments. For example, machine learning model 302 may represent a model used to generate predicted results values for a particular feature, such as predicted results 203, as shown in FIG. 2. The machine learning model may have been trained using training predictions and training labels (e.g., corresponding observed data). Machine learning model 302 may take input 304 (e.g., historic data, number of users, network resources, applications, predicted events, power consumption, processor usage, memory usage, network usage and/or other data) and may generate outputs 306 (e.g., predicted values). The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of the machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or a supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

Returning to FIG. 1, performance degradation identification system 102 may access a hierarchy associated with the features using hierarchy subsystem 116. For example, hierarchy subsystem 116 may receive a pre-generated hierarchy associated with the features via network 150. The hierarchy subsystem may organize the features into a structure with multiple levels. In some embodiments, hierarchy subsystem 116 may retrieve the organization schema and generate the hierarchy based on the scheme. For example, the organization schema may include a dependency structure for each feature or for some features of a dataset. In some embodiments, the top level of the hierarchy may be a single feature, which may be a target feature. For example, the target feature may be a feature of interest or an important feature within the system. In some embodiments, the target feature may be a feature depending on multiple other features within the system. In other words, the target feature may be a dependent variable while other features within the system are independent variables. The other features within the system may directly or indirectly feed into the target feature. The target feature may directly or indirectly feed into the other features within the system. In some embodiments, the target feature may have a discrepancy between predicted and actual values, where the discrepancy is caused by performance degradation of one or more machine learning models for other features within the system. In some embodiments, the initial target feature may be located elsewhere within the hierarchy. For example, hierarchy subsystem 116 may receive a pre-generated hierarchy via network 150 and may select, as an initial target feature, any feature within the hierarchy.

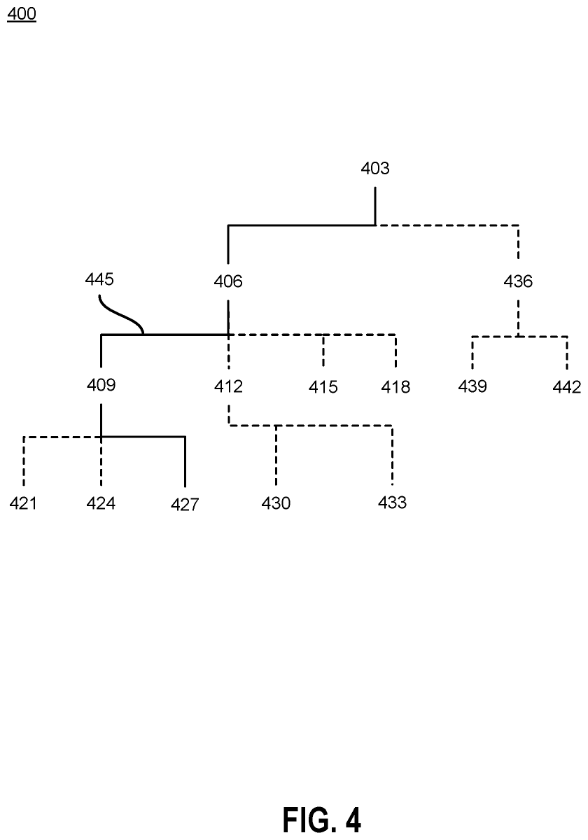

FIG. 4 illustrates a hierarchy 400 of features relating to a target feature, in accordance with one or more embodiments. For example, hierarchy 400 may include target feature 403 as well as features 406-442. In some embodiments, feature 406 and feature 436 may depend directly on target feature 403, feature 409, feature 412, and feature 415 depend directly on feature 406, and so on. In some embodiments, hierarchy subsystem 116 may select another feature within hierarchy 400 as the initial target feature. Hierarchy subsystem 116 may select feature 409 as the initial target feature if, for example, there is a discrepancy between predicted and actual values of feature 409 and performance degradation identification system 102 seeks to identify factors driving that discrepancy. In some embodiments, each of features 403-442 may be associated with a machine learning model (e.g., as illustrated in FIG. 3) which generates predicted values for the corresponding feature.

In some embodiments, hierarchy 400 may be oriented in a number of ways. For example, hierarchy 400 may be oriented downward, as shown in FIG. 4, or in another direction. For example, hierarchy 400 may be oriented upward such that a target feature is located at the bottom of the hierarchy (e.g., feature 427) and performance degradation identification system 102 determines an impact of changes in feature 427 on features at higher levels in the hierarchy (e.g., target feature 403). In some embodiments, hierarchy 400 may be a portion of a larger hierarchy received by hierarchy subsystem 116. In yet other embodiments, hierarchy 400 may be a portion of a different structure received by hierarchy subsystem 116. For example, hierarchy subsystem 116 may receive a larger hierarchy and may select a relevant portion of the hierarchy for performance degradation identification system 102 to process. Hierarchy subsystem 116 may receive a web structure with a target feature (e.g., target feature 403) at its center. Hierarchy subsystem 116 may generate hierarchy 400 by extracting relevant features extending from target feature 403 to the edge of the web. In some embodiments, hierarchy 400 may be represented by any other structure.

In some embodiments, hierarchy 400 may be a hierarchy of servers. Target feature 403 may represent a target server, or a server of interest. Each server in hierarchy 400 may be a server operating within a system. Servers may feed into each other, i.e., may transmit data and queries to other linked servers within the hierarchy. In some embodiments, target feature 403 may be a root server or domain name system (“DNS”) server. For example, the root server may directly respond to queries received by the system or may refer the queries to the next level of servers (e.g., feature 406 or feature 436), which may in turn refer queries downward (e.g., feature 406 may refer queries to any of feature 409, feature 412, feature 415). Each server may be associated with a machine learning model which predicts usage for that particular server. In this example, performance degradation identification system 102 may identify which server is associated with a machine learning model experiencing performance degradation that contributes the most to a difference between predicted and actual usage of the server.

In another example, hierarchy 400 may be a hierarchy of factors driving a financial status of a business. For example, target feature 403 may represent a return on equity for loans issued from a business. Features 406-442 may represent features driving the loan return on equity for the business. For example, feature 406 and feature 436 may be variables directly affecting the loan return on equity. Feature 406 may represent net income after taxes, features 409-418 may be variables directly affecting net income after taxes, such as revenue, expected loss, costs, etc., and so on. Each variable may be associated with a machine learning model which predicts values for that variable. Thus, performance degradation identification system 102 may identify which variable is associated with a machine learning model experiencing performance degradation that contributes the most to a difference between predicted and actual loan return on equity.

In some embodiments, hierarchy subsystem 116 may generate the hierarchy of features. For example, hierarchy subsystem 116 may retrieve the features (e.g., features 403-442) of a system from data node 104 and/or via network 150. The features may include an initial target feature (e.g., target feature 403). As discussed above, the initial target feature may be the feature for which driving causes of a discrepancy between actual and predicted values are to be determined by performance degradation identification system 102. Hierarchy subsystem 116 may then determine a first subset of the remaining features that are directly associated with the initial target feature. The first subset may include independent variables upon which the initial target feature directly depends. For example, feature 406 and feature 436 may be included in the first subset. Hierarchy subsystem 116 may determine a relationship between each feature of the first subset and the initial target feature. Determining the relationships may include identifying one or more dependencies between features of the subset and the target feature. Determining the relationships may include modeling the initial target features using the features of the first subset. Determining the relationships may comprise retrieving dependency information associated with the features from data node 104 or via network 150. In some embodiments, hierarchy subsystem 116 may determine the relationships in another manner. Hierarchy subsystem 116 may construct the first level of the hierarchy (e.g., feature 406 and feature 436) based on the determined relationships (e.g., with target feature 403).

Hierarchy subsystem 116 may determine, for each subsequent level of the hierarchy, subsequent relationships between features. For example, hierarchy subsystem 116 may determine, for the next level, features upon which feature 406 directly depends and features upon which feature 436 directly depends. Hierarchy subsystem 116 may determine that feature 406 directly depends upon feature 409, feature 412, feature 415, and feature 418, while feature 436 directly depends upon feature 439 and feature 442. Hierarchy subsystem 116 may construct the next level of the hierarchy based upon these dependencies. Hierarchy subsystem 116 may then repeat this process for each subsequent level of the hierarchy, for example, until each feature has been placed within the hierarchical structure. Thus, hierarchy subsystem 116 may generate, based on each relationship and each subsequent relationship, a structure including a number of levels, a particular subset of features on each level, and dependencies between the features.

Returning to FIG. 1, once hierarchy subsystem 116 has received or generated the hierarchy of features, performance degradation identification system 102 may select a first level of the hierarchy. For example, the first level of the hierarchy may indicate a first subset of the features. In some embodiments, the first level of the hierarchy may include features upon which the initial target feature depends. As shown in FIG. 4, the first level of the hierarchy may include feature 406 and feature 436.

Performance degradation identification system 102 (e.g., impact subsystem 118) may generate a first set of impact values for the first subset of features (e.g., feature 406 and feature 436). An impact value may be a metric for measuring a contribution of the corresponding feature to a difference, in the initial target feature (e.g., target feature 403), between predicted values and actual values. Impact values may be coefficients, and the magnitude of the coefficient may indicate the contribution of the corresponding feature to the aforementioned difference, in the initial target feature, between predicted and actual values.

In some embodiments, impact values may represent a population shift between predicted and actual values, a performance shift, an aggregation of population shift and performance shift, or some other metric. Population shift may represent differences between values of the predicted and actual datasets. For example, in the example of server usage, population shift may be caused by resource shortages, changes in usage patterns, external forces, or other causes. In some embodiments, the performance shift may represent differences between the predicted and actual datasets that are not attributable to the population shift. In some embodiments, performance shift may be characterized by changes in selected features between the predicted and actual datasets, reflecting a change in performance. For example, performance shift may represent model error of one or more machine learning models in performance degradation identification system 102.

Impact subsystem 118 may generate an impact value for each feature. In some embodiments, generating impact values may include estimating the impact values based on performance or population shift. In particular, generating an impact value may include estimating, for a feature, a coefficient of impact on the population shift of a target feature, and using the population shift and the estimated coefficient of impact for the feature, determining an impact (i.e., impact value) of the feature on the population shift of the target feature. The impact value may indicate a contribution of the feature to the population shift in the target feature. Generating impact is further discussed in U.S. Pat. No. 10,839,318, which is hereby incorporated in its entirety. Once the impact values are generated for the first level (e.g., for feature 406 and feature 436), impact subsystem 118 may determine which feature at that level has the highest impact value. For example, impact subsystem 118 may determine that feature 406 has a higher impact value than feature 436. In some embodiments, impact subsystem 118 may instead determine which feature at that level has the lowest impact value.

Impact values for a server load optimization system may indicate a contribution of each server within the hierarchy (e.g., features 406-442) to a difference between predicted and actual usage of a target server (e.g., target feature 403). For example, as discussed above, target feature 403 may be a root server which may directly respond to queries received by the system or may refer the queries to the next level of servers, and that level of servers may in turn refer queries downward, and so on. Each server within this hierarchical system may be associated with a machine learning model which predicts usage of the corresponding server. Performance degradation in any machine learning model associated with a server affects performance of the target server (e.g., target feature 403). This may lead to a discrepancy between predicted and actual usage of the target server. The impact value associated with each other server in the hierarchy indicates the contribution of that server to the discrepancy.

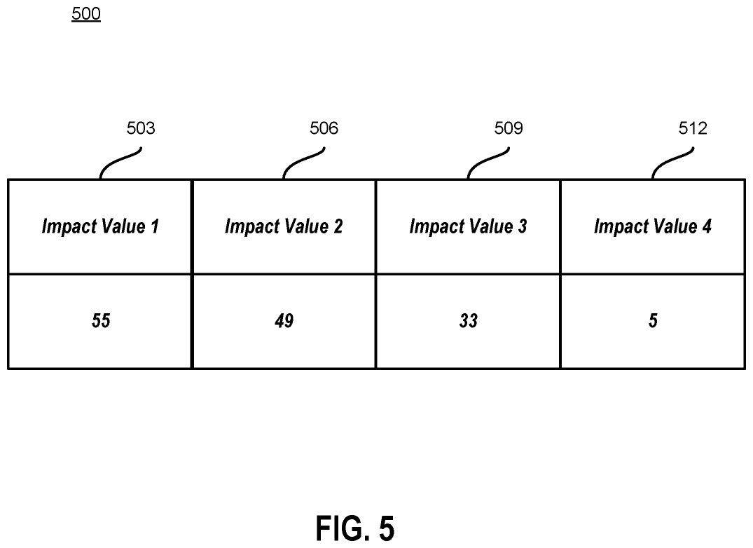

FIG. 5 illustrates a data structure 500 representing impact values, in accordance with one or more embodiments. Data structure 500 may represent a subset of a data structure including impact values for each feature within hierarchy 400. For example, impact value 503 may correspond to feature 409, impact value 506 may correspond to feature 412, impact value 509 may correspond to feature 415, and impact value 512 may correspond to feature 418. Each impact value may represent a magnitude of the contribution of the corresponding feature to a difference between predicted and actual values of the target feature (e.g., target feature 403). In this example, impact subsystem 118 may determine that, out of features 409-418, feature 409 has the highest impact value, i.e., impact value 503.

In some embodiments, impact subsystem 118 may identify an additional feature or additional features having impact values within a certain threshold of the highest impact value (e.g., impact value 503). For example, impact subsystem 118 may determine, for each level of the hierarchy based on sets of impact values, whether each level of the hierarchy comprises additional target features. Each additional target feature may have an impact value within a certain threshold of the highest impact value at that level. The threshold may be pre-determined for the system or may be set or adjusted based on user preferences or system goals. For example, a higher threshold may allow impact subsystem 118 to identify a larger number of features having high impact values. This may allow performance degradation identification system 102 to identify more features associated with machine learning models experiencing performance degradation. If the system aims to identify any feature contributing significantly to performance degradation, a higher threshold may be desirable. In this case, a threshold of at least six allows impact subsystem 118 to identify impact value 506 in addition to impact value 503. A threshold of at least twelve allows impact subsystem 118 to identify impact value 509 in addition to impact value 503 and impact value 506. If, for example, the system is aimed at identifying a single highest contributing factor to performance degradation, a lower threshold or no threshold may be desirable.

Once impact subsystem 118 identifies the highest impact value at each level, impact subsystem 118 may determine that the feature having the highest impact value is a new target feature for that level of the hierarchy. For example, at the first level of the hierarchy, impact subsystem 118 may determine that feature 406 has a higher impact value than feature 436. Therefore, impact subsystem 118 may determine that feature 406 is a new target feature for the first level. Impact subsystem 118 may repeat this process at the first level of the hierarchy using feature 406 as the new target feature. Impact subsystem 118 may determine impact values for each feature upon which feature 406 depends (e.g., feature 409, feature 412, feature 415, and feature 418). As discussed above in relation to FIG. 5, impact subsystem 118 may determine that feature 409 has the highest impact value of these features. Impact subsystem 118 may thus determine that feature 409 is the new target feature for this level of the hierarchy and may repeat the process using feature 409 as the new target feature. The new highest impact value associated with feature 409 may indicate a new contribution of the new target feature (e.g., feature 409) to a new difference, in a previous target feature (e.g., feature 406), between predicted and actual values. Impact subsystem 118 may continue to generate and compare impact values for each subsequent level of the hierarchy until the bottom of the hierarchy is reached or until some other stopping point. For example, performance degradation identification system 102 may receive a pre-determined stopping point such as a level in the hierarchy at which to stop or a particular feature at which to stop.

Impact subsystem 118 may select a final target feature at a final level of the hierarchy. For example, impact subsystem 118 may generate impact values for each feature upon which feature 409 depends (e.g., feature 421, feature 424, and feature 427). Impact subsystem 118 may determine that feature 427 has the highest impact value. Impact subsystem 118 may thus select feature 427 as the final target feature at the final level of the hierarchy.

As shown in FIG. 4, this iterative process allows performance degradation identification system 102 to identify a path (e.g., path 445) within hierarchy 400. The path traces the features (e.g., feature 406, feature 409, and feature 427) having the greatest contribution to performance degradation in target feature 403. If, at any level, impact subsystem 118 selects more than one new target feature (e.g., if another impact value falls within a threshold of the highest impact value at that particular level of the hierarchy), multiple paths may be formed. For example, impact subsystem 118 may identify feature 412 as having an impact value within a threshold of the highest impact value (e.g., associated with feature 409). Impact subsystem 118 may accordingly continue the iterative process for both feature 409 and feature 412, leading to two branches in path 445. Impact subsystem 118 may thus identify multiple final target features (e.g., feature 427 as well as feature 430 or feature 433).

Returning to FIG. 1, once impact subsystem 118 has identified the final target feature of the hierarchy, performance degradation identification system 102 (e.g., machine learning subsystem 114) may retrain the machine learning model corresponding to the final target feature. For example, machine learning subsystem 114 may retrain the machine learning model corresponding to the final target feature using a new training dataset. In some embodiments, the new training dataset may contain new training data. Machine learning subsystem 114 may retrieve the new training data from data node 104. The new training data may contain new inputs and output labels. In some embodiments, the new training data may be more robust than initial training datasets. In some embodiments, the new training data may reflect new circumstances within the system (e.g., number of users, network resources, applications, events, economic changes such as industry downturn, or other circumstances). Machine learning subsystem 114 may retrain the machine learning model using machine learning model training techniques discussed above in relation to FIG. 3.

In some embodiments, machine learning subsystem 114 may retrain multiple machine learning models. For example, as illustrated by FIG. 4, impact subsystem 118 may identify multiple target features (e.g., at least one target feature per level of hierarchy 400). The target features in hierarchy 400 may include target feature 403, feature 406, feature 409, and feature 427 (e.g., the features along path 445). In some embodiments, machine learning subsystem 114 may retrain some or all of the identified target features. For example, machine learning subsystem 114 may retrain every identified target feature within hierarchy 400. In some embodiments, machine learning subsystem 114 may retrain certain identified target features based on external criteria or circumstances (e.g., availability of new training datasets, allocation of resources, or other circumstances). In some embodiments, machine learning subsystem 114 may retrain additional target features identified within hierarchy 400 (e.g., along multiple branches of path 445). For example, if impact subsystem 118 identifies feature 412 as an additional target feature (e.g., having an impact value within a certain threshold of the highest impact value), machine learning subsystem 114 may retrain a machine learning model associated with feature 412. Machine learning subsystem 114 may additionally retrain machine learning models associated with any additional target features based on feature 412 (e.g., feature 430 or feature 433).

In some embodiments, retraining a machine learning model associated with a target feature may comprise receiving a command to retrain the machine learning model used to generate predicted values for the target feature. Machine learning subsystem 114 may, in response, extract the target feature from the hierarchy and access a new training dataset for the target feature. In some embodiments, machine learning subsystem 114 may access an indicator of a machine learning model used to generate predicted values for the target feature. Machine learning subsystem 114 may then access the new training dataset using the indicator. The new training dataset may include new predicted values and new actual values. Machine learning subsystem 114 may then retrain the machine learning model to generate the predicted values for the target feature using the new training dataset.

In some embodiments, once impact subsystem 118 has identified a particular target feature (e.g., the final target feature), performance degradation identification system 102 (e.g., communication subsystem 112) may output an alert including the target feature. In some embodiments, communication subsystem 112 may output the alert to one or more of user devices 108a-108n. Communication subsystem 112 may output an alert once the final target feature is identified. In some embodiments, the alert may comprise information about the identified target feature, a command to retrain a machine learning model associated with the identified target feature, an indicator pointing to the machine learning model associated with the identified target feature, an indicator associated with a new training dataset for the machine learning model, or additional information relating to the identified target feature. For example, communication subsystem 112 may output an alert for each identified target feature. In some embodiments, the alert may include multiple identified target features.

In some embodiments, communication subsystem 112 may output additional information, such as processing time of performance degradation identification system 102, the path of target features identified within the hierarchy (e.g., path 445), a confidence level of each identified target feature, or other information.

### Computing Environment

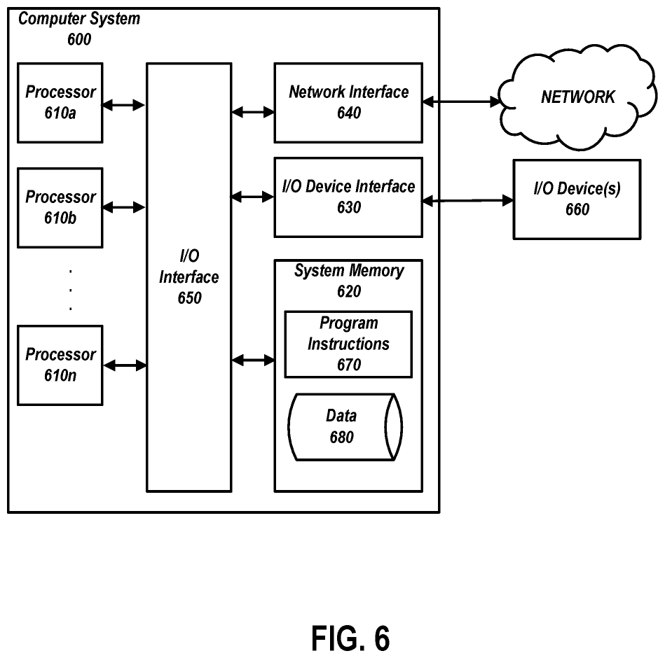

FIG. 6 shows an example computing system 600 that may be used in accordance with some embodiments of this disclosure. In some instances, computing system 600 is referred to as a computing system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows described herein, may be performed by one or more programmable processors executing one or more computer programs to perform functions by operating on input data and generating corresponding output. Processes described herein may be performed by, and apparatus can also be implemented as, special purpose logic circuitry, for example, an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computing system 600. I/O devices may include devices that receive input (e.g., from a user) or output information (e.g., to a user). I/O devices 660 may include, for example, a graphical user interface presented on displays (e.g., a cathode ray tube (CRT) or a liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing system 600 through a wired or wireless connection. I/O devices 660 may be connected to computing system 600 from a remote location. I/O devices 660 located on remote computer systems, for example, may be connected to computing system 600 via a network and network interface 640.

Network interface 640 may include a network adapter that provides for connection of computing system 600 to a network. Network interface 640 may facilitate data exchange between computing system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 600, or multiple computer systems 600 configured to host different portions or instances of embodiments. Multiple computer systems 600 may provide for parallel or sequential processing/execution of one or more portions of the techniques described herein.

Those skilled in the art will appreciate that computing system 600 is merely illustrative, and is not intended to limit the scope of the techniques described herein. Computing system 600 may include any combination of devices or software that may perform or otherwise provide for the performance of the techniques described herein. For example, computing system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computing system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

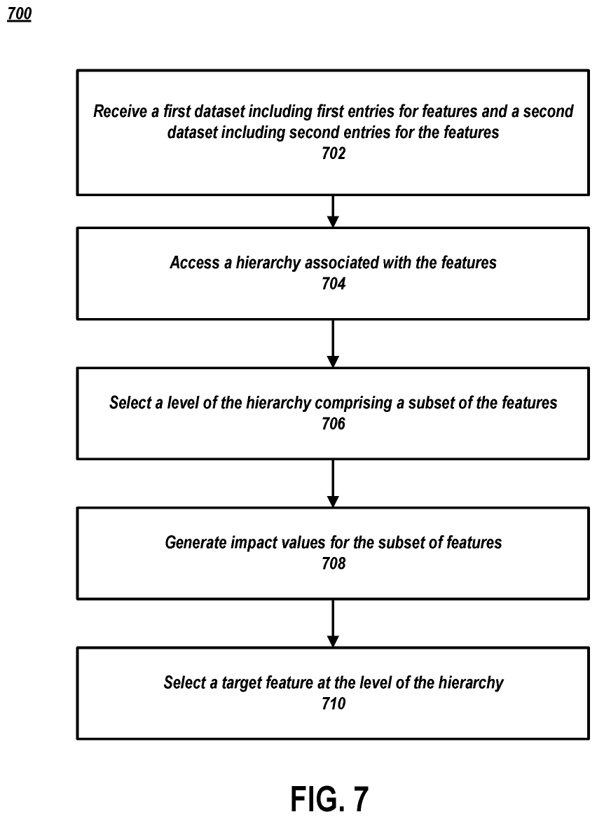

FIG. 7 shows a flowchart of the process 700 for identifying performance degradation in machine learning models, in accordance with one or more embodiments. For example, the system may use process 700 (e.g., as implemented on one or more system components described above) to determine which features in a system are contributing most to differences between predicted and actual datasets.

At step 702, process 700 (e.g., using one or more of processors 610a-610n) receives a first dataset and a second dataset. The first dataset may include first entries for features and the second dataset may comprise second entries for the features. In some embodiments, the first entries may comprise predicted data for each feature. For example, the predicted data may be generated by a corresponding machine learning model associated with each feature. Each machine learning model may be stored on a network, in data 680, or elsewhere. In some embodiments, the second entries may comprise observed data for each feature. The observed data may be received via the network.

In some embodiments, process 700 (e.g., using one or more of processors 610a-610n) may generate the first and second datasets. For example, process 700 may receive, from a corresponding machine learning model associated with each feature, predicted data for each feature of the plurality of features. Each machine learning model may be stored on a network, in data 680, or elsewhere. Process 700 may receive, based on observations associated with each feature, observed data for each feature of the plurality of features. The observed data may be received via the network. Process 700 may then generate the first dataset including the predicted data for each feature and the second dataset including the observed data for each feature.

At step 704, process 700 (e.g., using one or more of processors 610a-610n) accesses a hierarchy associated with the features. For example, process 700 may access the hierarchy via the network, from data 680, or elsewhere. In some embodiments, process 700 may generate the hierarchy based on dependencies between target features and corresponding subsets of features. The dependencies may be determined based on feature relationship data received via the network, from data 680, or elsewhere. Process 700 may store the hierarchy in data 680.

At step 706, process 700 (e.g., using one or more of processors 610a-610n) selects a level of the hierarchy including a subset of the features. For example, process 700 may select the level based on an initial target feature, which may be received via the network, from data 680, or elsewhere. The subset of the features may correspond to the initial target feature. At step 708, process 700 (e.g., using one or more of processors 610a-610n) generates a set of impact values for the subset of the plurality of features. Each impact value of the set of impact values may indicate a contribution of a corresponding feature to a difference, in the target feature, between the first dataset and the second dataset (i.e., predicted and actual results). Process 700 may store the set of impact values in data 680.

At step 710, process 700 (e.g., using one or more of processors 610a-610n) selects a target feature at the level of the hierarchy. The target feature may be the feature, of the subset of features, having the highest impact value. In some embodiments, process 700 may store the target feature in data 680. In some embodiments, process 700 may output an alert including the target feature (e.g., via I/O interface 650 or I/O device(s) 660).

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 7.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising receiving a first dataset comprising a first plurality of entries for a plurality of features and a second dataset comprising a second plurality of entries for the plurality of features, accessing a hierarchy associated with the plurality of features, wherein the hierarchy comprises a plurality of levels, selecting a level of the hierarchy comprising a subset of the plurality of features, wherein the subset is associated with a target feature of the plurality of features, generating a set of impact values for the subset of the plurality of features, wherein each impact value of the set of impact values indicates a contribution of a corresponding feature to a difference, in the target feature, between the first dataset and the second dataset, selecting a new target feature at the level of the hierarchy, wherein the new target feature is associated with a highest impact value corresponding to the level of the hierarchy, and outputting an alert comprising the new target feature.
2. The method of any one of the preceding embodiments, further comprising receiving, from a corresponding machine learning model associated with each feature, predicted data for each feature of the plurality of features, receiving, based on observations associated with each feature, observed data for each feature of the plurality of features, generating the first dataset comprising the first plurality of entries, wherein the first plurality of entries comprises the predicted data for each feature of the plurality of features, and generating the second dataset comprising the second plurality of entries, wherein the second plurality of entries comprises the observed data for each feature of the plurality of features.
3. The method of any one of the preceding embodiments, further comprising receiving, in response to the alert, a command to retrain a machine learning model used to generate predicted values for the new target feature, extracting the new target feature from the hierarchy, accessing a new training dataset comprising new predicted values and new actual values for the new target feature, and retraining the machine learning model used to generate the predicted values for the new target feature using the new training dataset.
4. The method of any one of the preceding embodiments, further comprising accessing, within the level of the hierarchy, an indicator of a machine learning model used to generate predicted values for the new target feature, accessing, using the indicator, a new training dataset for the machine learning model comprising new predicted values and new actual values for the new target feature, and retraining the machine learning model using the new training dataset.
5. The method of any one of the preceding embodiments, further comprising determining, for each subsequent level of the hierarchy based on subsequent sets of impact values, a subsequent target feature at each subsequent level of the hierarchy having a subsequent highest impact value.
6. The method of any one of the preceding embodiments, further comprising determining, for each subsequent level of the hierarchy based on the subsequent sets of impact values, whether each subsequent level of the hierarchy comprises additional target features, wherein each additional target feature has an impact value within a certain threshold of the highest impact value at each subsequent level, and in response to determining that one or more subsequent levels comprise one or more additional target features, retraining one or more additional machine learning models used to generate predicted values for the one or more additional target features using a new training dataset.
7. The method of any one of the preceding embodiments, further comprising determining a relationship between each feature of the subset of the plurality of features and the target feature, wherein determining the relationship comprises identifying one or more dependencies between features of the subset and the target feature, determining, for each subsequent level of the hierarchy, a subsequent relationship between each feature of each subsequent set and each respective subsequent target feature, wherein determining each subsequent relationship comprises identifying one or more subsequent dependencies between subsequent features of each subsequent set and each respective subsequent target feature, and generating, based on the relationship and each subsequent relationship, the hierarchy comprising the plurality of features.
8. The method of any one of the preceding embodiments, wherein generating the hierarchy comprises generating, based on each relationship and each subsequent relationship, a structure comprising a number of levels, a particular subset of the plurality of features on each level, the one or more dependencies, and the one or more subsequent dependencies.
9. A tangible, non-transitory, machine-readable medium storing instructions that, when executed by a data processing apparatus, cause the data processing apparatus to perform operations comprising those of any of embodiments 1-8.
10. A system comprising one or more processors; and memory storing instructions that, when executed by the processors, cause the processors to effectuate operations comprising those of any of embodiments 1-8.
11. A system comprising means for performing any of embodiments 1-8.
12. A system comprising cloud-based circuitry for performing any of embodiments 1-8.

What is claimed is:

1. A system for identifying performance degradation in one or more machine learning models based on comparison of actual and predicted results, the system comprising:
one or more processors; and
a non-transitory, computer-readable medium comprising instructions that when executed by the one or more processors cause operations comprising:
receiving (1) a predicted results dataset comprising a first plurality of entries for a plurality of features, wherein the first plurality of entries comprises predicted data for each feature of the plurality of features, the predicted data generated by a corresponding machine learning model associated with each feature and (2) an actual results dataset comprising a second plurality of entries for the plurality of features, wherein the second plurality of entries comprises observed data for each feature of the plurality of features;
accessing a hierarchy associated with the plurality of features, wherein the hierarchy comprises an initial target feature and a plurality of levels, each level indicating a subset of features of the plurality of features;
selecting a first level of the hierarchy, wherein the first level of the hierarchy indicates a first subset of the plurality of features;
generating a first set of impact values for the first subset of the plurality of features, wherein each impact value of the first set of impact values indicates a contribution of a corresponding feature to a difference, in the initial target feature, between predicted values of the predicted results dataset and actual values of the actual results dataset;
determining, for each subsequent level of the hierarchy based on the first set of impact values and subsequent sets of impact values, a feature at each subsequent level of the hierarchy having a highest impact value;
selecting a final target feature at a final level of the hierarchy, wherein the final target feature is associated with a final highest impact value corresponding to the final level of the hierarchy; and
retraining a machine learning model used to generate final predicted values for the final target feature using a new training dataset.

2. The system of claim 1, wherein determining the corresponding feature at each level of the hierarchy having the highest impact value further comprises:
determining, based on each subsequent set of impact values, a new target feature for each subsequent level of the hierarchy,
wherein the new target feature is associated with a new highest impact value, and
wherein the new highest impact value indicates a new contribution of the new target feature to a new difference, in a previous target feature, between new predicted values of the predicted results dataset and new actual values of the actual results dataset.

3. The system of claim 1, further comprising:
determining, for each level of the hierarchy, the feature having the highest impact value;
identifying the corresponding machine learning model used to generate corresponding predicted values for each feature having the highest impact value; and
retraining each corresponding machine learning model using the new training dataset.

4. The system of claim 1, further comprising:
determining, for each subsequent level of the hierarchy based on the first set of impact values and the subsequent sets of impact values, whether each subsequent level of the hierarchy comprises additional target features, wherein each additional target feature has an impact value that meets a threshold; and
in response to determining that one or more subsequent levels comprise one or more additional target features, retraining one or more additional machine learning models used to generate additional predicted values for the one or more additional target features using the new training dataset.

5. A method comprising:
receiving a first dataset comprising a first plurality of entries for a plurality of features and a second dataset comprising a second plurality of entries for the plurality of features;
accessing a hierarchy associated with the plurality of features, wherein the hierarchy comprises a plurality of levels;
selecting a level of the hierarchy comprising a subset of the plurality of features, wherein the subset is associated with a target feature of the plurality of features;
generating a set of impact values for the subset of the plurality of features, wherein each impact value of the set of impact values indicates a contribution of a corresponding feature to a difference, in the target feature, between the first dataset and the second dataset;
selecting a new target feature at the level of the hierarchy, wherein the new target feature is associated with a highest impact value corresponding to the level of the hierarchy; and
outputting an alert comprising the new target feature.

6. The method of claim 5, further comprising:
receiving, from a corresponding machine learning model associated with each feature, predicted data for each feature of the plurality of features;
receiving, based on observations associated with each feature, observed data for each feature of the plurality of features;
generating the first dataset comprising the first plurality of entries, wherein the first plurality of entries comprises the predicted data for each feature of the plurality of features; and
generating the second dataset comprising the second plurality of entries, wherein the second plurality of entries comprises the observed data for each feature of the plurality of features.

7. The method of claim 6, further comprising:
receiving, in response to the alert, a command to retrain a machine learning model used to generate predicted values for the new target feature;
extracting the new target feature from the hierarchy;
accessing a new training dataset comprising new predicted values and new actual values for the new target feature; and
retraining the machine learning model used to generate the predicted values for the new target feature using the new training dataset.

8. The method of claim 6, further comprising:
accessing, within the level of the hierarchy, an indicator of a machine learning model used to generate predicted values for the new target feature;
accessing, using the indicator, a new training dataset for the machine learning model comprising new predicted values and new actual values for the new target feature; and
retraining the machine learning model using the new training dataset.

9. The method of claim 5, further comprising determining, for each subsequent level of the hierarchy based on subsequent sets of impact values, a subsequent target feature at each subsequent level of the hierarchy having a subsequent highest impact value.

10. The method of claim 9, further comprising:
determining, for each subsequent level of the hierarchy based on the subsequent sets of impact values, whether each subsequent level of the hierarchy comprises additional target features, wherein each additional target feature has an impact value within a certain threshold of the highest impact value at each subsequent level; and
in response to determining that one or more subsequent levels comprise one or more additional target features, retraining one or more additional machine learning models used to generate predicted values for the one or more additional target features using a new training dataset.

11. The method of claim 9, further comprising:
determining a relationship between each feature of the subset of the plurality of features and the target feature, wherein determining the relationship comprises identifying one or more dependencies between features of the subset and the target feature;
determining, for each subsequent level of the hierarchy, a subsequent relationship between each feature of each subsequent set and each respective subsequent target feature, wherein determining each subsequent relationship comprises identifying one or more subsequent dependencies between subsequent features of each subsequent set and each respective subsequent target feature; and
generating, based on the relationship and each subsequent relationship, the hierarchy comprising the plurality of features.

12. The method of claim 11, wherein generating the hierarchy comprises generating, based on each relationship and each subsequent relationship, a structure comprising a number of levels, a particular subset of the plurality of features on each level, the one or more dependencies, and the one or more subsequent dependencies.

13. A non-transitory, computer-readable medium, comprising instructions that, when executed by one or more processors, cause operations comprising:
receiving a first dataset comprising a first plurality of entries for a plurality of features and a second dataset comprising a second plurality of entries for the plurality of features;
accessing a hierarchy associated with the plurality of features, wherein the hierarchy comprises a plurality of levels;
selecting a level of the hierarchy comprising a subset of the plurality of features, wherein the subset is associated with a target feature of the plurality of features;
generating a set of impact values for the subset of the plurality of features, wherein each impact value of the set of impact values indicates a contribution of a corresponding feature to a difference, in the target feature, between the first dataset and the second dataset;
selecting a new target feature at the level of the hierarchy, wherein the new target feature is associated with a highest impact value corresponding to the level of the hierarchy;
identifying a machine learning model associated with the new target feature; and
retraining the machine learning model using a new training dataset.

14. The non-transitory, computer-readable medium of claim 13, further comprising:
receiving, from a corresponding machine learning model associated with each feature, predicted data for each feature of the plurality of features;
receiving, based on observations associated with each feature, observed data for each feature of the plurality of features;
generating the first dataset comprising the first plurality of entries, wherein the first plurality of entries comprises the predicted data for each feature of the plurality of features; and
generating the second dataset comprising the second plurality of entries, wherein the second plurality of entries comprises the observed data for each feature of the plurality of features.

15. The non-transitory, computer-readable medium of claim 14, further comprising:
outputting an alert comprising the new target feature;
receiving, in response to the alert, a command to retrain the machine learning model associated with the new target feature;
extracting the new target feature from the hierarchy; and
accessing the new training dataset comprising new predicted values and new actual values for the new target feature.

16. The non-transitory, computer-readable medium of claim 14, further comprising:
accessing, within the level of the hierarchy, an indicator of the machine learning model associated with the new target feature; and
accessing, using the indicator, the new training dataset for the machine learning model comprising new predicted values and new actual values for the new target feature.

17. The non-transitory, computer-readable medium of claim 13, further comprising determining, for each subsequent level of the hierarchy based on subsequent sets of impact values, a subsequent target feature at each subsequent level of the hierarchy having a subsequent highest impact value.

18. The non-transitory, computer-readable medium of claim 17, further comprising:
determining, for each subsequent level of the hierarchy based on the subsequent sets of impact values, whether each subsequent level of the hierarchy comprises additional target features, wherein each additional target feature has an impact value within a certain threshold of the highest impact value at each subsequent level; and
in response to determining that one or more subsequent levels comprise one or more additional target features, retraining one or more additional machine learning models used to generate predicted values for the one or more additional target features using the new training dataset.

19. The non-transitory, computer-readable medium of claim 17, further comprising:
determining a relationship between each feature of the subset of the plurality of features and the target feature, wherein determining the relationship comprises identifying one or more dependencies between features of the subset and the target feature;
determining, for each subsequent level of the hierarchy, a subsequent relationship between each feature of each subsequent set and each respective subsequent target feature, wherein determining each subsequent relationship comprises identifying one or more subsequent dependencies between subsequent features of each subsequent set and each respective subsequent target feature; and
generating, based on the relationship and each subsequent relationship, the hierarchy comprising the plurality of features.

20. The non-transitory, computer-readable medium of claim 19, wherein generating the hierarchy comprises generating, based on each relationship and each subsequent relationship, a structure comprising a number of levels, a particular subset of the plurality of features on each level, the one or more dependencies, and the one or more subsequent dependencies.
